(19) United States
(12) Patent Application Publication
(10) Pub. No.: US 2008/0032037 A1
(43) Pub. Date: Feb. 7, 2008

(54) Radiation-Curing Method For Coatings

(75) Inventors: Thomas Frey, Mannheim (DE); Karl Graf, Ludwigshafen (DE); Manfred Biehler, Ilbesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/597,823

(22) PCT Filed: May 21, 2005
(86) PCT No.: PCT/EP05/05517

§ 371 Date: Nov. 24, 2006

(30) Foreign Application Priority Data
May 26, 2004 (DE) 10 2004 026 325.6
Jul. 20, 2004 (DE) 10 2004 035 066.3

(51) Int. Cl. B05D 3/00

(52) U.S. Cl. 427/9

(57) ABSTRACT

A method of determining conditions at least necessary for radiation curing pigmented radiation-curable coating materials, and an associated apparatus.

The present invention relates to a method of determining the conditions at least necessary for radiation curing pigmented radiation-curable coating materials and also to associated apparatus and a business method.

Radiation curing for producing transparent coatings such as clearcoats or topcoats, for example, is an industrially established technology with great advantages such as high operating speed, solvent freedom, and high crosslinking density.

Unlike their transparent counterparts, pigmented coating materials per se are difficult to cure by radiation, since the pigments they comprise absorb and reflect the radiation and hence only a small part of the irradiated energy dose is actually able effectively to bring about curing. The use of radiation curing for colored and opaque coatings is therefore hindered by the interaction of the pigments used with the radiation, whose intensity is attenuated. Volume curing of the coating particularly at its underside, i.e., down to the substrate, can be reduced as a result of the pigmentation to the point where the coating becomes unusable.

There has been no lack of attempts to extend radiation curing to pigmented coating materials. Such attempts have involved exposing the coating materials to radiation for a duration empirical data suggested would lead to volume curing.

A disadvantage is that the empirical basis can be determined only by series experiments and does not possess any predictive power.

Particularly when the intention is to introduce a new pigmentation or level of pigmentation (pigmenting concentration), for which no empirical data are available, new formulations have to date only been possible by experimental determination in laborious new test series on the basis of trial and error.

In view of the lack of predictive power of an empirical basis of this kind, the coating materials are generally exposed to radiation either for longer than necessary, leading to unnecessary blocking of the capital-intensive illumination equipment and hence to unfavorable plant utilization, or for not long enough, leading to a coating which is not cured right through its volume, and therefore having an adverse effect on the adhesion or hardness of the coating, for example, and possibly leading to off-specification batches.

Hauser, Osterloh and Jacobi described at the XIV FATIPEC Congress, Jun. 4-9, 1978, Budapest, pp. 241-247, especially chap. 6 therein, the effect of energy distribution of a UV lamp, absorption spectra of a photoinitiator and absorption spectra of pure pigments on the anticipated UV curing.

A disadvantage of this is that with this method it is possible only to evaluate existing pigmentations, no predictions being possible in relation to pigment compositions not hitherto measured. Furthermore, Hauser et al. start from the absorption spectrum of a photoinitiator and do not recognize that this absorption spectrum does not necessarily coincide with its spectral activability (see below).

The technical object of the present invention was to provide a method allowing on the one hand the suitability or nonsuitability of radiation curing to be predicted for a specified pigmentation of a coating and on the other hand allowing the variables for radiation curing to be determined in such a way that sufficient volume curing can be expected.

This object is achieved by a method of determining the conditions for radiation curing radiation-curable pigmented coating materials comprising at least one pigment P, at least one binder B and at least one photoinitiator I on a substrate, comprising the steps of
a) specifying a pigment composition or if appropriate determining the pigment composition required to obtain the desired color impression,
b) measuring the reflection spectra of the pigments P present in the pigment composition, as a function of their concentration, composition and/or coat thickness,
c) determining the concentration-specific absorption spectra K(λ) and scattering spectra S(λ) of the individual pigments from the reflection spectrum measured in b), in the desired wavelength range λ,
d) measuring the reflection of the substrate in the desired spectral range,
e) determining the values for total absorption Kₜ(λ) and total scattering Sₜ(λ) of the coating material on the substrate from the values from c) and d) for the desired pigment composition,
f) determining the integral transmission Tᵢ for the pigment composition in the desired wavelength range, and
g) determining the variables necessary for radiation curing on the basis of the integral transmission Tᵢ determined in f).

An advantage of the present invention is that the scope of experimental test series can be substantially reduced, the utilization of the exposure units can be optimized, and off-specification batches due to inadequate radiation can be avoided.

Within this specification the terms-are used as follows:

The term “pigments” is used comprehensively in this specification for pigments in the true sense, dyes and/or fillers and extenders, preferably for pigments in the true sense and fillers or extenders, and more preferably for pigments in the true sense.

Pigments in the true sense are, according to CD Römpp Chemie Lexikon—Version 1.0, Stuttgart/New York: Georg Thieme Verlag 1995, referring to DIN 55943, particulate “colorants which are virtually insoluble in the application medium, are organic or inorganic, and are chromatic or achromatic”.

“Virtually insoluble” denotes in the context a solubility at 25° C. of less than 1 g/1000 g application medium, preferably less than 0.5, more preferably less than 0.25, very preferably less than 0.1 and in particular below 0.05 g/1000 g application medium.

Examples of pigments in the true sense comprise any desired systems of absorption pigments and/or effect pigments, preferably absorption pigments. There are no restrictions on the number or selection of the pigment components. They can be adapted as desired to the particular requirements, as for example to the desired color impression, as described for example in step a). The basis may be, for example, all of the pigment components of a standardized mixer paint system.

By effect pigments are meant all pigments which exhibit a platelet-shaped construction and impart specific decorative color effects to a surface coating. The effect pigments comprise, for example, all of the effect-imparting pigments which can be employed commonly in vehicle finishing and industrial coating. Examples of effect pigments of this kind are pure metal pigments, such as aluminum, iron or copper pigments, interference pigments, such as titanium dioxide-coated mica, iron-oxide-coated mica, mixed oxide-coated mica (e.g., with titanium dioxide and Fe₂O₃ or titanium dioxide and Cr₂O₃), and metal oxide-coated aluminum, and liquid-crystal pigments.

The color-imparting absorption pigments are, for example, customary organic or inorganic absorption pigments which can be used in the paint industry. Examples of organic absorption pigments are azo pigments, phthalocyanine pigments, quinacridone pigments, and pyrrolopyrrole pigments. Examples of inorganic absorption pigments are iron oxide pigments, titanium dioxide, and carbon black.

Dyes are likewise colorants and differ from the pigments in their solubility in the application medium, i.e., they have a solubility at 25° C. of more than 1 g/1000 g in the application medium.

Examples of dyes are azo, azine, anthraquinone, acridine, cyanine, oxazine, polymethine, thiazine, and triarylmethane dyes. These dyes can be employed as basic or cationic dyes, mordant dyes, direct dyes, disperse dyes, developing dyes, vat dyes, metal complex dyes, reactive dyes, acid dyes, sulfur dyes, coupling dyes or substantive dyes.

Coloristically inert fillers are all substances/compounds which on the one hand are coloristically inactive—that is, they exhibit little intrinsic absorption and have a refractive index similar to that of the coating medium—and on the other hand are capable of influencing the orientation (parallel alignment) of the effect pigments in the surface coating, i.e., in the applied paint film, and also properties of the coating or of the coating materials, such as hardness or rheology. Inert substances/compounds which can be used are given by way of example below, but without restricting the concept of coloristically inert, topology-influencing fillers to these examples. Suitable inert fillers meeting the definition may be, for example, transparent or semitransparent fillers or pigments, such as silica gels, Blanc fixe, kieselguhr, talc, calcium carbonates, kaolin, barium sulfate, magnesium silicate, aluminum silicate, crystalline silicon dioxide, amorphous silica, aluminum oxide, microspheres, including hollow microspheres, composed for example of glass, ceramic or polymers, with sizes of for example 0.1-50 μm. Additionally as inert fillers it is possible to employ any desired solid inert organic particles, such as urea-formaldehyde condensation products, micronized polyolefin wax and micronized amide wax, for example. The inert fillers can in each case also be used in a mixture. It is preferred, however, to use only one filler in each case.

By the coating medium is meant the pigment-surrounding medium, examples being clearcoats, binders, powders, for powder coatings for example, polymeric films or sheets.

By the coating material is meant the composition comprising coating medium (binder) and pigment.

By the coating is meant the applied and dried and/or cured coating material.

The at least one binder B may be selected from any desired radiation-curable compounds. These can be free-radically or cationically polymerizable compounds comprising at least one C—C multiple bond. Preferably the at least one binder B comprises at least one free-radically polymerizable bond, more preferably from 1 to 20 ethylenically unsaturated double bonds, very preferably 1-10, in particular 1-6, and especially 2-4 free-radically polymerizable bonds.

The free-radically polymerizable ethylenically unsaturated double bonds are preferably acrylate or methacrylate groups, more preferably acrylate groups, and the cationically polymerizable ethylenically unsaturated double bonds are preferably vinyl ether groups. The amount of unsaturated free-radically or cationically polymerizable groups may amount for example to at least 0.01 mol/100 g of compound, preferably at least 0.05, more preferably at least 0.1, and in particular at least 0.2 mol/100 g.

The number-average molecular weight Mₙ of these compounds, determined by gel permeation chromatography using tetrahydrofuran as eluent and polystyrene as standard, can amount for example to between 200 and 200000, preferably between 250 and 100000, more preferably between 350 and 50000, and in particular between 500 and 30000.

The binders may be, for example, commercially customary radiation-curable products, examples being methacrylic or, preferably, acrylic esters of polyetherols, polyesterols, urethanes, amino resins, polyacrylates or epoxy resins, optionally alkoxylated monoalcohols, optionally alkoxylated polyalcohols, reactive diluents or mixtures thereof, and also polyfunctional polymerizable compounds.

Polyfunctional polymerizable compounds, in other words polyfunctional (meth)-acrylates, for example, carry at least 2, preferably 3-10, more preferably 3-6, very preferably 3-4, and in particular 3 (meth)acrylate groups, preferably acrylate groups.

These compounds may be, for example, esters of (meth)acrylic acid with polyalcohols which correspondingly have a functionality of at least two and if appropriate are alkoxylated.

Examples of such polyalcohols are at least divalent polyols, polyetherols or polyesterols or polyacrylatepolyols having a mean OH functionality of at least 2, preferably from 3 to 10.

Suitable alkylene oxides for alkoxylation are for example ethylene oxide, propylene oxide, isobutylene oxide, vinyloxirane and/or styrene oxide.

The alkylene oxide chain may be composed preferably of ethylene oxide, propylene oxide and/or butylene oxide units. Such a chain may be composed of one species of an alkylene oxide or of a mixture of alkylene oxides. If a mixture is used, the different alkylene oxide units may be present randomly or as a block or blocks of individual species. A preferred alkylene oxide is ethylene oxide, propylene oxide or a mixture thereof, particular preference being given to ethylene oxide or propylene oxide, and very particular preference to ethylene oxide.

The number of alkylene oxide units in the chain is for example from 1 to 20, preferably from 1 to 10, more preferably 1-5 and in particular 1-3, and very preferably 1, based on the respective hydroxyl groups of the polyalcohol.

The molecular weights Mₙ of the polyesterols or polyetherols are preferably between 100 and 4000 (Mₙ determined by gel permeation chromatography with polystyrene as standard and tetrahydrofuran as eluent).

Further possible polyfunctional (meth)acrylates are polyester (meth)acrylates, epoxy (meth)acrylates, urethane (meth)acrylates or (meth)acrylated polyacrylates. Instead of the (meth)acrylate groups it is also possible to use other free-radically or cationically polymerizable groups.

Urethane (meth)acrylates, for example, are obtainable by reacting polyisocyanates with hydroxyalkyl(meth)acrylates or hydroxyalkyl vinyl ethers and, if appropriate, chain extenders such as diols, polyols, diamines, polyamines, dithiols or polythiols.

Particularly preferred polyfunctional (meth)acrylates are trimethylolpropane tri(meth)-acrylate, (meth)acrylates of ethoxylated and/or propoxylated trimethylolpropane, pentaerythritol, glycerol or ditrimethylolpropane. Particular preference is given to acrylates of ethoxylated and/or propoxylated trimethylolpropane or pentaerythritol. Reactive diluents are for example esters of (meth)acrylic acid with alcohols having 1 to 20 carbon atoms, examples being methyl(meth)acrylate, ethyl(meth)acrylate, butyl (meth)acrylate, 2-ethylhexyl(meth)acrylate, 2-hydroxyethyl acrylate, 4-hydroxybutyl acrylate, dihydrodicyclopentadienyl acrylate, vinylaromatic compounds, e.g., styrene and divinylbenzene, α,β-unsaturated nitriles, e.g., acrylonitrile and methacrylonitrile, α,β-unsaturated aldehydes, e.g., acrolein and methacrolein, vinyl esters, e.g., vinyl acetate and vinyl propionate, halogenated ethylenically unsaturated compounds, e.g., vinyl chloride and vinylidene chloride, conjugated unsaturated compounds, e.g., butadiene, isoprene and chloroprene, monounsaturated compounds, e.g., ethylene, propylene, 1-butene, 2-butene and isobutene, cyclic monounsaturated compounds, e.g., cyclopentene, cyclohexene and cyclododecene, N-vinylformamide, allyl acetic acid, vinyl acetic acid, monoethylenically unsaturated carboxylic acids having 3 to 8 carbon atoms and their water-soluble alkali metal, alkaline earth metal or ammonium salts, such as, for example: acrylic acid, methacrylic acid, dimethylacrylic acid, ethacrylic acid, maleic acid, citraconic acid, methylenemalonic acid, crotonic acid, fumaric acid, mesaconic acid and itaconic acid, maleic acid, N-vinylpyrrolidone, N-vinyl lactams, such as N-vinylcaprolactam, N-vinyl-N-alkyl-carboxamides or N-vinyl-carboxamides, such as N-vinylacetamide, N-vinyl-N-methylformamide and N-vinyl-N-methylacetamide, or vinyl ethers, e.g., methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, 4-hydroxybutyl vinyl ether, and mixtures thereof.

As photoinitiators I it is possible to use photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Ed.), SITA Technology Ltd, London.

By these photoinitiators are meant those which under light exposure release free radicals and are able to initiate a free-radical reaction, such as a free-radical addition polymerization, for example.

Suitable examples include phosphine oxides, benzophenones, α-hydroxyalkyl aryl ketones, thioxanthones, anthraquinones, acetophenones, benzoins and benzoin ethers, ketals, imidazoles or phenylglyoxylic acids and mixtures thereof.

Examples of phosphine oxides include mono- or bisacylphosphine oxides, such as Irgacure® 819 (bis(2,4,6-trimethylbenzoyl)phenylphosphine oxide), as are described, for example, in EP-A 7 508, EP-A 57 474, DE-A 196 18 720, EP-A 495 751 or EP-A 615 980, such as 2,4,6-trimethylbenzoyldiphenylphosphine oxide (Lucirin® TPO), ethyl 2,4,6-trimethylbenzoylphenylphosphinate or bis(2,6-dimethoxybenzoyl)-2,4,4-tri-methylpentylphosphine oxide;

examples of benzophenones include benzophenone, 4-aminobenzophenone, 4,4′-bis-(dimethylamino)benzophenone, 4-phenylbenzophenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone;

examples of α-hydroxyalkyl aryl ketones include 1-benzoylcyclohexan-1-ol (1-hydroxycyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or a polymer comprising 2-hydroxy-2-methyl-1-(4-isopropen-2-ylphenyl)propan-1-one units (Esacure® KIP 150);

examples of xanthones and thioxanthones include 10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone or chloroxanthenone;

examples of anthraquinones include β-methylanthraquinone, tert-butylanthraquinone, anthraquinonecarbonyl acid esters, benz[de]anthracen-7-one, benz[a]anthracene-7,12-dione, 2-methylanthraquinone, 2-ethylanthraquinone, 2-tert-butylanthraquinone, 1-chloroanthraquinone or 2-amylanthraquinone;

examples of acetophenones include acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one;

examples of benzoins and benzoin ethers include 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; and

examples of ketals include acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Examples of photoinitiators which can additionally be used include benzaldehyde, methyl ethyl ketone, 1-naphthaldehyde, triphenylphosphine, tri-o-tolylphosphine or 2,3-butanedione. Typical mixtures include for example 2-hydroxy-2-methyl-1-phenylpropan-2-one and 1-hydroxycyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenylpropan-1-one, 2,4,6-trimethylbenzophenone and 4-methylbenzophenone, or 2,4,6-trimethylbenzophenone and 4-methylbenzophenone and 2,4,6-trimethylbenzoyldiphenylphosphine oxide.

As further typical coatings additives in the coating materials it is possible for example to add antioxidants, oxidation inhibitors, stabilizers, activators (accelerators), dyes, devolatilizers, lustrants, antistats, flame retardants, thickeners, thixotropic agents, flow assistants, binders, antifoams, fragrances, surface-active agents, viscosity modifiers, plasticizers, tackifying resins (tackifiers), chelating agents or compatibilizers.

Besides radiation curing, the coating materials may also be curable by further curing mechanisms (dual cure or multicure); by the latter is meant, for the purposes of this specification, a curing process which takes place by way of two, or more than two, mechanisms, respectively, selected for example from radiation, moisture, chemical, oxidative and/or thermal curing, preferably selected from radiation, moisture, chemical and/or thermal curing, more preferably selected from radiation, chemical and/or thermal curing, and with very particular preference radiation curing and chemical curing.

In particular, however, the method of the invention can be used for curing exclusively radiation-curable coating materials.

The substrates which can be coated using the method of the invention are not subject to any restriction. They may be composed for example of wood, paper, textile, leather, nonwoven, plastics surfaces, glass, ceramic, mineral building materials, such as cement moldings and fiber cement slabs, or coated and uncoated metals, preferably plastics or metals, which may for example also be in the form of sheets.

Among the plastics mention will be made by name of polyethylene, polypropylene, polystyrene, polybutadiene, polyesters, polyamides, polyethers, polyvinyl chloride, polycarbonate, polyvinyl acetal, polyacrylonitrile, polyacetal, polyvinyl alcohol, polyvinyl acetate, phenolic resins, urea resins, melamine resins, alkyd resins, epoxy resins or polyurethanes, their block or graft copolymers, and blends thereof. Particular mention may be made of ABS, AES, AMMA, ASA, EP, EPS, EVA, EVAL, HDPE, LDPE, MABS, MBS, MF, PA, PA6, PA66, PAN, PB, PBT, PBTP, PC, PE, PEC, PEEK, PEI, PEK, PEP, PES, PET, PETP, PF, PI, PIB, PMMA, POM, PP, PPS, PS, PSU, PUR, PVAC, PVAL, PVC, PVDC, PVP, SAN, SB, SMS, UF and UP polymers (abbreviations in accordance with DIN 7728), and aliphatic polyketones.

The individual steps of the method of the invention are explained in more detail below:

Step a): Specifying a pigment composition or if appropriate determining the pigment composition required to obtain the desired color impression.

The coating material whose use is envisaged or whose suitability for curing is to be ascertained comprises at least one pigment P and may be composed of one or more pigments P₁, P₂, . . . with given proportions m₁, m₂, . . . .

The respective proportions of the pigment composition may originate, for example, from a paint formula calculation and may be set so that the coating produces a specified shade. The paint formula calculation may have been carried out on the basis of the K(λ) and S(λ) spectra determined according to b) and d) or by means of a separate color formulating system.

The optical properties of a coating comprising a variety of pigments are composed, in accordance with a formalism which the theory used must supply, of the optical properties of the individual pigments and their respective fraction in the overall pigmentation.

Methods of paint formulation are available and are known per se to the skilled worker; one example is the paint formulation in accordance with EP-B1 931 247 (=U.S. Pat. No. 6,064,487).

Step b): Measuring the reflection spectra of the pigments P present in the pigment composition, for the individual pigments, as a function of their concentration, composition and/or coat thickness.

The ability of a coating material to undergo curing through volume is influenced by pigments which interact with the curing radiation, i.e., which absorb, reflect and/or scatter said radiation. Therefore wavelength-dependent identifying numbers are determined for the absorption properties (K) and scattering properties (S) of all of the pigments present, P₁, P₂, . . . , which are part of the pigmenting composition of a coating material intended for volume curing, with the aim of calculating—without further experimental tests—the ability of the coating material to undergo curing through volume.

For the stated purpose each individual one of these pigments P₁, P₂, . . . , is incorporated into a coating medium, for the purpose of recording calibration measurements, in various concentrations: for example, in fractions of 0.1-30%, preferably 0.1 to 25% and more preferably 0.3-15% by weight with respect to the coating material. This coating material is provided with at least one binder, which is preferably the same as the abovementioned at least one binder B but need not necessarily be the same, since in general it is possible to disregard the influence of the binder on absorption and scattering, which is preferably the case in accordance with the invention.

The binder in step b) need not necessarily be radiation-curable but preferably is so.

Approaches based on defined mixtures of different pigments are also suitable. The coating medium should be preferably as close as possible to, or identical with, the coating medium which is to be employed for the method, in terms of its optical properties (after film formation) and its dispersing action.

Coating medium may be, for example, a liquid or powder clearcoat; curing to produce the coating may take place by radiation curing and/or otherwise (for example, thermally or at room temperature, two-component reaction). The degree of curing is irrelevant for these calibration measurements provided it does not affect the optical properties or the composition of the coating and the coating has sufficient mechanical load-bearing capacity for the measurement.

The differently pigmented coating materials are applied by means of a suitable technique, e.g., knife coating, spraying, electrodeposition, pouring, brushing, spincoating or squirting; pigmented sheets or slot extrudates are also possible. Application takes place to an appropriate substrate, examples being sheet-metal panels. The substrate must have at least two areas which differ in that they have different reflection values, e.g., <40% and >60%, across the entire wavelength range subsequently considered, such as from 200 to 2500 nm, for example. Both areas must be overcoated in the course of application.

The substrate may have been given a primer treatment, an example being a coated adhesion primer.

The target coat thickness should be similar to that in the subsequent method and is generally from 1 to 200 μm, preferably 2-200 μm, more preferably 2-150 μm, and very preferably from 5 to 150 μm. The actual coat thicknesses of the dry coatings above the substrate are measured.

Reflection spectra of the coating are measured over both substrates for the entire wavelength range subsequently considered. Measurement takes place with a suitable spectrometer, a UV/VIS spectrometer for example. Where only the influence of the pigments on the curing radiation in a wavelength range above 360-400 nm is to be calculated, the reflection measurement can take place using a calorimeter; the precise lower and upper limit of the measurement range is dependent on the instrument.

The measuring geometry in terms of illumination/observation radiation ought to take account of the diffuse reflection component. Examples of possible geometries include the following: 8°/diffuse, 0°/diffuse, 0°/45°, X°/Y° (with 0°<X<80° and 0°<Y<80°), and the respective inverse geometries (=inverted beam direction). The nomenclature here is such that irradiation perpendicular to the plane of the sample is denoted 0° and the stated angles relate to the deviation from said perpendicular. The diffuse reflection is measured, correspondingly, over the entire range of the sample plane, i.e., from +90° to −90°. The measurement can be made with or without—preferably with—gloss included.

Also possible in principle is application to a transparent substrate in different coat thicknesses, followed by transmission measurements, with a measurement geometry such as 0°/diffuse, for example.

All of the measured or calculated spectra of the present invention can be smoothed arithmetically by methods known per se, although such smoothing is not necessary in accordance with the invention.

Step c): Determining the concentration-specific absorption spectra K(λ) and scattering spectra S(λ) of the individual pigments from the reflection spectrum measured in b) in the desired wavelength range λ.

The skilled worker is familiar with mathematical theories which describe the propagation of electromagnetic radiation within a pigmented medium as a function of the spectral absorption and scattering taking place therein. Any theory which provides a solution for determining the transmission of a coating comprising two or more pigments from properties of the individual pigments can be used for the method of the invention.

As an established theory, and the most simple, it is preferred here to employ the Kubelka-Munk theory (KMT, two-channel model). The intention of the developers of this theory was to describe the optical behavior of pigmented material in the visible spectral range. The formalism of this theory is employed, in accordance with the invention, beyond the boundaries of the visible, for the UV or IR spectral range as well.

The principles of this theory are set out in Hans G. Völz, Industrial Color Testing, Weinheim: VCH Verlagsges., 2nd ed. 2001, in sections 3.3, 4.5, 7.2.1 and 7.2.2.

It is, however, also possible to use other formulations of the radiation transport equation to describe the circumstances involved in electromagnetic radiation passing through a particulate medium in which the radiation is partially scattered and/or absorbed. These models for calculating reflection, scattering and transmission properties of pigmented media are based predominantly on the Mie theory and in general make use of the optical parameters, derived therefrom, of absorption coefficient, scattering coefficient and the phase function from the description of individual pigment particles.

Particularly for describing effect paints, i.e., coating materials which comprise effect pigments, it may be necessary to employ the four-channel model or the multichannel theory, as it is known (method of discrete ordinates), which breaks down the radiation field into a relatively large number of radiation flows in different directions and considers the anisotropy of individual scattering processes.

The principles of these theories are set out in Hans G. Völz, Industrial Color Testing, Weinheim: VCH Verlagsges., 2nd ed. 2001, in sections 3.1.2, 3.2 and 7.2.3.

The Kubelka-Munk theory represents a phenomenological approach of describing the transport of radiation in media having scattering and/or absorbing properties, which with gross simplification considers the passage of light in only two directions: that is, perpendicularly into the medium, and in the opposite direction out again. In further critical assumptions it is assumed that the scattering is isotropic and that, owing to the multiple scattering processes which take place, the distribution of light within the coat possesses a purely diffuse character. Within the bounds of this theory it is possible to give analytical expressions for transmission (transmittance, T) and reflection (reflectance, R) of plan parallel turbid media for the case of diffuse illumination and hemispherical observation of the transmitted and reflected radiation, respectively. Both parameters are functions of the absorption coefficient (K) and of the scattering coefficient (S), of the coat thickness (SD) under consideration, and of the reflection properties of the surfaces bounding the coat, after Saunderson correction if appropriate (see below).

According to the corresponding equations of the KMT (P. Kubelka, F. Munk, Zeitschrift für technische Physik, 11a (1931), p. 593) an absorption (K) spectrum and scattering (S) spectrum is calculated over the entire desired wavelength range for each of the pigments measured under b), from the reflection spectra obtained under b) and d) and from the specified or desired coat thickness SD (Hans G. Völz, Industrial Color Testing, Weinheim: VCH Verlagsges., 2nd ed. 2001, page 102).

For this purpose the reflection spectra of the respective pigment-comprising coating over the different substrates and also the reflection spectra of the substrates are preferably subjected to the mathematical Saunderson correction in order to eliminate effects of internal reflection at surfaces; equations for this purpose can be found in Hans G. Völz, Industrial Color Testing, Weinheim: VCH Verlagsges., 2nd ed. 2001, page 75-78.

For the Saunderson correction the parameters r₀ (external reflection coefficient) for the reflectivity of the coating surface with respect to directed radiation incident from the outside, and r₂ (internal reflection coefficient) with respect to diffuse radiation incident from the inside, are necessary. When the Saunderson correction is applied to the KMT, customary values are r₀=0.04 and r₂=0.6. The values for r₀ and r₂ are dependent on the refractive index n of the medium and can be adapted as a function of said refractive index. The stated values for r₀ and r₂ are typical values for media having a refractive index of approximately n≈1.5.

The Saunderson correction can be disregarded if, for example, the refractive indices are 1 or close to 1, e.g., 1.3 or below.

The refractive index and hence the reflectivity of transparent media generally increases as the wavelength goes down and becomes greater in the UV spectral range than in the visual range (Cauchy behavior), so that other values for r₀ may lead to a better arithmetic result: for example, from 0.03 to 0.07, preferably from 0.04 to 0.06, and more preferably from 0.04 to 0.05.

With respect to r₂ it should be borne in mind that a component of the measuring radiation reflected directively at the metallic substrate can lead to a reduced internal reflection, so that values for r₂<0.6 may lead to a better arithmetic result in describing the interaction of the pigments with the curing radiation: for example, from 0 to 0.6, preferably from 0.1 to 0.5, more preferably from 0.2 to 0.4.

Where they are known, it is also possible to use wavelength-dependent values for r₀ and r₂.

The desired wavelength range λ comprises the wavelength range in which the radiation curing takes place, i.e., the wavelength range of the radiation unit with which radiation curing is to be implemented, and, if appropriate, the wavelength range of visible light as well. Preferably this wavelength range should cover the absorption spectrum and more preferably the activation spectrum of the at least one photoinitiator I that is used. By way of example, the desired wavelength range is from 200 to 2500 nm, preferably from 200 to 2000, more preferably from 200 to 1500, very preferably from 200 to 1000, and in particular from 200 to 780 nm.
Step d): Measuring the reflection of the substrate in the desired spectral range.
In the same way as described under b) the reflection spectra of the two substrates, i.e., for the at least two areas with different reflection values, are measured at uncoated sites and/or pieces of substrate of the same kind. In this way it is possible to draw up a data collection for typical substrates.
Step e): Determining the values for total absorption Kₜ(λ) and total scattering Sₜ(α) of the coating material on the substrate from the values from c) and d) for the desired pigment composition.

The coating material whose use is envisaged or whose suitability for curing is to be ascertained comprises a pigmentation which may be composed of one or more pigments with given proportions, the pigmenting composition of which has been specified or if appropriate determined in step a).

The optical properties of a coating comprising different pigments are composed, in accordance with a formalism which the theory used must supply, of the optical properties of the individual pigments and their respective weight proportion in the overall pigmentation.

According to KMT the K(λ) and the S(λ) values of a pigmentation composed of two or more pigments are additive at each wavelength. To describe the optical properties of the overall pigmentation a total absorption Kₜ(λ) spectrum and a total scattering Sₜ(λ) spectrum are calculated by proportionally weighted addition of the K(λ) and S(λ) values for the individual pigments (Q. B. Judd, G. Wyszecki, Color in Business, Science, and Industry, 2nd ed, John Wiley and Sons, New York, 1963, p. 413).

The at least one photoinitiator I in the coating material absorbs irradiation of the lamp in just the same way as pigments, and can therefore be treated like a pigment; that is, a K(λ) spectrum can be generated for it and included in the calculation of Kₜ(λ).

Step f): Determining the integral transmission Tᵢ for the pigment composition in the desired wavelength range.

The curing of a coating material through its volume down to the substrate in the course of radiation curing is critical to the performance suitability of the coating. The adhesion to the substrate, in particular, depends on whether sufficient molecular crosslinking reactions have taken place at the boundary layer between coating and substrate. This presupposes that in the course of the curing operation (i.e., in the course of irradiation) sufficient radiation energy suitable for exciting the photoinitiator is deposited in this boundary layer, i.e., reaches said layer.

One measure of the radiation energy deposited there is the intensity of the exciting radiation at this point. A measure of the intensity of the exciting radiation at the lower interface of the coating is the transmission of the coating, in other words the ratio of the intensity of radiation of a given spectral distribution after passing through the coating with a given coat thickness SD to the intensity it had prior to penetrating the coating.

According to the KMT the transmission T(λ) of a coat with coat thickness SD and optical properties characterized by its Kₜ(λ) and Sₜ(λ) spectrum is calculated for each wavelength in the spectral range relevant for curing (preferably 250450 nm) (Völz, Industrial Color Testing, Weinheim: VCH Verlagsges., 2nd ed. 2001, p. 97).

Depending on the respective curing method it is possible to employ different radiation sources with differing spectral distribution B(λ) of the radiation power, i.e., different emission spectra. The radiation intensity arriving at the lower interface of the coating depends in each case proportionally on T(λ) and on B(λ).

Therefore, as a measure of the transparency of the coating material for the curing radiation, the mean transmission Tᵢ, weighted by the intensity distribution of a given radiation source, referred to below as integral transmission,
Tᵢ=Σ(t_{λ}·b_{λ})/Σ(b_{λ}),

is calculated from the spectral individual values t_{λ} for transmission and b_{λ} for the incident radiation intensity, the individual values being intended each to possess the same wavelength distances, e.g., 1-20 nm, preferably 2-15 nm, more preferably 3-10 nm, and very preferably 5-10 nm. The summation (or, analogously, an integration) comprises reasonably the spectral range which is relevant for the cure, preferably 250 to 450 nm, and more preferably the wavelength range in which the photoinitiator can be activated and within which b_{λ}≠0.

The integral transmission Tᵢ is a measure of the radiation energy deposited in the boundary layer to the substrate and is therefore suitable for comparing different pigments with one another in respect of their anticipated volume curing.

The degree of curing caused by the UV radiation energy introduced depends also, however, on the spectral activability a(λ) of the at least one photoinitiator I used, which need not necessarily coincide with its absorption spectrum (see below). The greater the difference between the spectral transmission distributions of different pigmentations under comparison, the greater the effect of this, since, of course, the photoinitiator is advantageously activable only in a wavelength range in which the pigmentation surrounding it is particularly transparent, i.e., exhibits a significant transmission. On the other hand, the effect of the spectral activability of the photoinitiator is mostly negligible in the case of what are called white reductions, i.e., in the case of paints containing chromatic pigments and having a high content, in comparison therewith, of pigments which scatter colorlessly, examples being titanium dioxide pigments or calcium carbonate pigments, since the preferred, colorlessly scattering pigments, such as titanium dioxide, for example, possess pronounced absorption at short wavelengths and hence limit the excitation of the photoinitiator to the spectral range with greater wavelengths (for titanium dioxide approximately >370 nm). A consequence of this is that, when using a white reduction pigment, no advantage is generally obtained by, on the one hand, using a photoinitiator which is activable in a spectral range below about 370 nm and, on the other hand, considering the activability of the photoinitiator for wavelengths below 370 nm.

In accordance with the invention it is possible additionally, as a measure of the reaction conversion, to define the activation A. The reaction conversion under consideration is based on the formation of free radicals by a photoinitiator, with subsequent reaction. For each wavelength λ the spectral contribution to the activation of the crosslinking reaction is given by the product of the intensity of the radiation at the interface to the substrate (radiation intensity; see definition of integral transmission) and the activability of the photoinitiator, given by the corresponding individual spectral values a_{λ} (see below). The overall activation A of the crosslinking reaction in the interface region is given by summing the individual spectral contributions.
A=Σ(t_{λ}·b_{λ}·a_{λ})/(Σ(b_{λ})·Σ(a_{λ}))

Individual contributions for wavelengths for which the exciting radiation energy or the activability of the photoinitiator is zero do not contribute to sum. The summing (or, by analogy, an integration) reasonably comprises the spectral range that is relevant for the cure, preferably 250 to 450 nm, and more preferably the wavelength range in which the photoinitiator is activable and within which it is the case that b_{λ}≠0.

The activability is a spectrally dependent variable, given by the individual spectral values a_{λ}, the intention being that the individual values a_{λ} should each have equal wavelength spacings, e.g., 1-20 nm, preferably 2-15, more preferably 3-10, and very preferably 5-10 nm. Each individual spectral value a_{λ} describes the reaction conversion per radiation intensity at wavelength λ with a given wavelength spacing. Relevant for the radiation intensity is its value at the boundary between coating and substrate.

The activation A may be a better measure of the through-volume curing than the integral transmission Tᵢ. However, the spectral activability of a photoinitiator is not necessarily identical with its absorption spectrum and is therefore difficult and inconvenient to determine. In a first approximation it can be assumed that activability spectrum and absorption spectrum of the photoinitiator are coincident. However, it is a preferred embodiment of the present invention to determine the activability of the photoinitiator.

One possibility for determining the spectral activability of a photoinitiator/photoinitiator mixture is to expose a radiation-curable coating film that has been provided with the photoinitiator to be characterized, said exposure taking place with monochromatic light, e.g., from lasers or a monochromator, and subsequently determining the degree of cure achieved, on the basis of a suitable indicator. e.g., hardness, elasticity modulus, adhesion, swelling resistance, or to determine the reaction conversion achieved in a direct manner on the basis of the chemically reacted double bonds, by Raman spectroscopy, for example, as a function of the irradiated wavelength λ.

A further possibility is first to set, empirically, an activability spectrum of the photoinitiator, in accordance with example with its readily obtainable absorption spectrum, and to coordinate this spectrum, taking into account the irradiated wavelengths, with the activation values calculated therefor, on the basis of a correlation of the curing results of UV coating materials with different pigmentations, whose transmission in the wavelength range under consideration can be determined, for example, by one of the methods set out above, or else to optimize said spectrum by means of empirical methods or a suitable algorithm.

Step g): Determining the variables necessary for the desired radiation curing on the basis of the integral transmission Tᵢ determined in f). The determination of the variables on the basis of the activation A determined in f) could take place analogously.

Whether the desired volume curing of a given pigment composition in a pigmented coating occurs or does not occur in a given radiation curing process depends
1.) on the transparency of the coating for the radiation exciting the photoinitiator, characterized by Tᵢ (see above), and
2.) on the radiation energy E introduced into the coating, determined by the radiation power and the type of radiation source, composed for example of one or more lamps, the distance of the substrate from the radiation source, the belt speed, the length of the section, the number of passes, or other measures of the residence time, the atmosphere in which curing is implemented, and, if appropriate, the nature and amount of the at least one photoinitiator I that is used.
3.) on the properties of the photoinitiator. Therefore, in one preferred embodiment of the invention, in addition to 1.) and 2.), the activability of the photoinitiator used is taken into account.

Since E is different for different processes, a critical integral transmission T_{i,crit} is determined for each process which the coating must at least have in order to achieve the desired volume curing through the entire pigmented coat down to the substrate.

For this purpose, once per curing operation, i.e., for the radiation source to be used, with the envisaged belt speed and with the envisaged number of exposures, and also for the desired photoinitiator, a test series is produced from a plurality of coatings, preferably 3-7 coatings, which differ in at least one variable that forms part of the calculation of Tᵢ: for example, the concentration of one or more pigments and/or the coat thickness. All of the coatings of this test series are treated by the given operation, keeping the operational properties the same, and then tested for their volume curing. The Tᵢ of the coating which with the lowest Tᵢ just meets the volume curing requirements is set as T_{i,crit}.

When T_{i,crit} has been determined for the curing operation defined by the above variables, the volume curing can be calculated for each pigmentation employed thence; generally there is no longer a need for further experiments, provided radiation source and output, belt speed, number of passes, and type and amount of photoinitiator are maintained.

Since the output characteristics of a lamp may vary during its lifetime it may be necessary to test it at intervals and, if it falls below certain limit values, to change the lamp.

Volume curing, i.e., the ability to cure through volume, can be tested preferably by means of tests of a kind which examine the adhesion of the coating by imposing a load on the coating parallel to the substrate, such as the rub test described below.

As a rough guideline, scratch resistance can be tested by means of standardized tests, as for example by the Scotch-Brite test, as described in WO 02/00754, p. 17, lines 1-4, brush tests, as described for example in P. Betz, A. Bartelt, Progress in Organic Coatings, 22, 1993, pp. 27-37, adhesive tape pulloff or adhesion with cross-cut in accordance with DIN 53151.

The calculation of Tᵢ is based, in one preferred embodiment of the invention, on the optical properties of the individual pigments, described by their K(λ) and S(λ) spectra in accordance with the KMT. Since these spectra generally embrace the spectral range for curing radiation and the entire visual spectral range, it is possible, when the pigmentation variables are varied, to calculate the change in the expected color and derived coloristic properties simultaneously. This is done by calculating the reflection spectrum of the coating from K(λ) and S(λ) using a Saunderson correction (Hans G. Völz, Industrial Color Testing, Weinheim: VCH Verlagsges., 2nd ed. 2001, page 97 and 75-78); from the reflection spectrum it is possible to determine, for example, the color locus by DIN 5033, the color distance from another given color locus, by DIN 6174, or the depth of color of the coating, by DIN 53235.

If by observing the desired coating properties, e.g., color, coloristics or species and concentration of pigment, it is not possible to achieve the condition whereby Tᵢ≧T_{i,crit}, then it is possible to adopt the following procedure:
new pigments are employed to calculate Tᵢ, so that the process is started again from step a) above, and/or
the coat thickness SD and/or the pigmentation composition can be adjusted arithmetically so that the desired properties are met. Then, with the pigment species and its proportions retained, the coat thickness is reduced to a value SDᵣ until Tᵢ≧T_{i,crit}. In this case, a coating cured right through its volume can be expected when the number of coats of reduced coat thickness SDᵣ applied one above another and cured is such that the overall coat thickness SD is reached.

The invention additionally provides a method of radiation curing radiation-curable pigmented coating materials comprising at least one pigment P, at least one binder B and at least one photoinitiator I on a substrate, comprising steps a) to g) above and additionally
h) implementing radiation curing of the coating on the basis of the variables determined in g).

The coating is then cured with the given operation using the variables determined under g).

Radiation curing can take place, generally speaking, in the wavelength range, for example, from 200 to 2500 nm, preferably in the UV, visible and/or NIR range, more preferably in the UV and/or visible range, and very preferably in the UV range.

Examples of suitable radiation sources for radiation curing include low-, medium- and high-pressure mercury lamps, which may be undoped, doped with gallium or doped with iron, and also fluorescent tubes, pulsed lamps, metal halide lamps, electronic flash devices, which allow radiation curing without a photoinitiator, or excimer lamps. Radiation curing is accomplished by exposure to electromagnetic radiation, i.e., NIR and/or UV radiation and/or visible light, preferably light in the wavelength range λ of from 200 to 780 nm, more preferably from 200 to 500 nm, and very preferably from 250 to 430 nm. Radiation sources used include, for example, doped or undoped high-pressure mercury vapor lamps, lasers, pulsed lamps (flash light), halogen lamps or excimer lamps. The radiation dose normally sufficient for crosslinking in the case of UV curing is in the range from 80 to 3000 mJ/cm².

It is of course also possible to use two or more radiation sources for curing: for example, from two to four.

These radiation sources may also emit each in different wavelength ranges.

Irradiation can also be carried out if appropriate under an atmosphere with reduced oxygen partial pressure or in the absence of oxygen, e.g., under an inert gas atmosphere. Suitable inert gases include, preferably, nitrogen, noble gases, carbon dioxide or combustion gases. Irradiation may additionally take place by covering the coating material with transparent media. Examples of transparent media include polymeric films, glass or liquids, e.g., water. Particular preference is given to irradiation of the kind described in DE-A1 199 57 900.

It is of course also possible to carry out radiation curing with a higher irradiated radiation energy than the irradiated radiation energy E given in g) by the curing operation considered there; for example, with up to 200% of E, preferably with up to 150%, more preferably with up to 130%, and very preferably with up to 120% of E. The exposure variables can be varied correspondingly: for example, the residence time in the unit can be increased, by means for example of slowing the belt speed, or the number of passes through the unit can be increased. This may, however, entail possibly unnecessary blocking of the irradiation unit.

The present invention additionally provides a business method which involves carrying out the steps set out above, up to and including step g), separately from step h). This may mean, for example, that a user wishing to carry out radiation curing (step h)) is supplied by a supplier with information on the manner of optimum implementation and/or the minimum requirements of radiation curing, as determined by the steps up to and including g). This may comprise, for example, Tᵢ, SDᵣ or alternative pigment preparations for obtaining the desired color impression.

The way in which this takes place may be, for example, that a program with an attached database, in which the basic data (K(λ), S(λ)) of customary commercial pigments have been collated, is passed onto the user, or the program is made available—on the Internet, for example, or via the World Wide Web—to the user, publicly or in a password-protected area, or the information necessary for radiation curing is supplied by the supplier to the user on request, by telephone, in writing or person to person, for a desired pigmentation composition or for obtaining a specific color impression, for example.

This method may additionally comprise the user being provided with a program for which the supplier, on request if appropriate, subsequently supplies updated basic data for pigments (K(λ) and S(λ) from step b) and c)) and/or reflectance values for substrates (from step d)). Such updating or access to a database containing the basic data may again take place by means of software update, Internet or World-Wide Web.

The present invention further provides apparatus for implementing radiation curing, comprising at least one illumination unit and at least one arithmetic unit and also if appropriate at least one measuring unit, the arithmetic unit being used to determine the information for implementing radiation curing in the steps up to and including g) as set out above and the illumination unit being used to implement radiation curing with said information thus determined.

The flow of information between arithmetic unit and illumination unit may take place directly, i.e., by the illumination unit being driven by the arithmetic unit, or indirectly, i.e., by manual operation of the illumination unit on the basis of the values determined by the arithmetic unit.

In one preferred embodiment the arithmetic unit acts on the illumination unit and regulates on said unit the residence time of the objects that are to be cured in the illumination unit, by means, for example, of adapting the belt speed, for different pigment compositions with which the objects are coated. For that purpose the total K and total S values (Kₜ(λ) and Sₜ(λ) from step e)) for different pigment compositions are stored for the arithmetic unit and the residence time of the objects in the illumination system is adapted by the arithmetic unit in accordance with the pigment composition.

In the measurement unit, a UV/VIS spectrometer, for example, the respective steps b) and d) are performed. The measurement unit is preferably separate from the illumination unit and also does not act directly on it.

The present invention further provides for the use of such apparatus in radiation curing.

The examples which follow are intended to illustrate the properties of the invention, though without restricting it.

### EXAMPLES

“Parts” or “%” in this text, unless otherwise specified, should be understood as “parts by weight” or “% by weight”.

Step b)

The yellow pigment Paliogen® L2140 from BASF AG was dispersed in a dispersing binder composed of 80 parts of Laromer® LR 8863 from BASF AG and 20 parts of Laromer® LR 9013 from BASF AG (2 h Skandex) and processed by letdown with Laromer® LR 9007 from BASF AG and addition of the photoinitiators Lucirin® TPO from BASF AG (1% based on total pigmented paint) and Darocure® 1173 from Ciba Spezialitätenchemie (2% based on total pigmented paint) to give UV-curable paints with pigment concentrations of 1%, 5% and 10%.

These paints were applied using a spiral wound doctor blade (nominal layer thickness 50 μm) in each case to a black or bright aluminum panel, as different substrates (contrast panel-manufacturer: Müller & Bauer GmbH & Co. 72555 Metzingen; aluminum panel-manufacturer: Meier & Co., 58103 Hagen), these panels having been coated in each case with clear adhesion primer 3034/8: 70 parts of Acronal® S 716 from BASF AG, 30 parts of Laromer® LR 8949 from BASF AG, 1 part of Irgacure® 184 from Ciba Spezialitätenchemie (50% in butyl glycol), 0.5% of Acrysol® RM 8 W from Rohm & Haas (10% in water).

Curing took place in a UV curing system from IST (type: U-300-M-2-TR) comprising one CK(“Hg”) medium-pressure mercury lamp and one CK1 (“Ga”) lamp with 2 passes at a belt speed of 5 m/min. The radiation outputs of the lamps, integrated over UV-A, UV-B, UV-C and UV-V, were about 255 W/cm² for CK and about 275 W/cm² for CK1. The corresponding dose figures for one pass at a belt speed of 5 m/min are about 1600 J/cm² for CK and about 1700 J/cm² for CK1.

The coat thicknesses, determined using a QuaNix 1500 coat thickness meter from Automation Dr.Nix GmbH, Cologne were 30 μm over both substrates.

The spectral reflection of the coatings over bright aluminum (a) and black (b) substrate were measured using a UV/VIS/NIR spectrometer CARY5 (Varian) employing an integration sphere with 8°/diffuse measurement geometry, with inclusion of gloss, in the spectral range 200-1000 nm with a distance between measurement points of 5 nm (FIG. 1).

Step d)

The spectral reflection of the aluminum substrate from b), carrying an adhesion primer, was measured on uncoated sites on all three reference preparations. The black substrate was measured only on one uncoated black panel, since it was found that the deviation in reflection values for different black panels among those used was negligible. The measurements were made, as in b), using a UV/VIS/NIR spectrometer CARY5 (Varian) employing an integration sphere with 8°/diffuse measurement geometry, with inclusion of gloss, in the spectral range 200-1000 nm or 200-800 nm with a distance between measurement points of 5 nm (FIG. 2).

Step c)

For each pigment concentration from b) the reflection spectra measured over the various substrates and also the reflection spectra of the two substrates from d) were subjected to mathematical Saunderson correction, with values for the external and internal reflection coefficients of r₀=0.04 and r₂=0.6 (FIGS. 3 and 4).

Two reflection spectra for each pigment concentration over bright aluminum and black substrate, respectively, contain the information on the scattering and absorption of the pigments present and are employed for calculating K(λ) and S(λ).

The Saunderson-corrected reflection spectra of the coatings and of the associated adhesion-primed substrates (FIG. 4) were used to carry out concentration-specific calculation of the K(λ) and S(λ) spectra for each pigment concentration in accordance with the formalism of the KMT (FIGS. 5 and 6).

The calculations for each wavelength are as follows:
S=[1/(b·SD·C)]·arcoth [(1−a·(ρ_{w}*+ρ_{0w}*)+ρ_{w}*·ρ_{0w}*)/(b·(ρ_{w}*−ρ_{0w}*))],
Unit: (μm·%)⁻¹
and
K=S·(a−1),
Unit: (μm·%)⁻¹
where
b=√(a²−1)
a=[(1+ρ_{w}*·ρ_{0w}*)·(ρₛ*−ρ₀ₛ*)+(1+ρₛ*·ρ₀ₛ*)·(ρ_{0w}*−ρ_{w}*)]/[2·(ρₛ*·ρ_{0w}*−ρ_{w}*·ρ₀ₛ*)]

In these equations
ρ_{w}* is the wavelength-dependent reflectance of the coating over the more highly reflecting substrate
ρₛ* is the wavelength-dependent reflectance of the coating over the less highly reflecting substrate
ρ_{0w}* is the wavelength-dependent reflectance of the more highly reflecting substrate
ρ₀ₛ* is the wavelength-dependent reflectance of the less highly reflecting substrate
SD is the thickness of the coating in μm
C is the concentration of the pigment in the coating in % by weight

The index * indicates that the reflectances labeled therewith have undergone Saunderson correction:
ρ*=(ρ−r₀)/[1−r₀−r₂·(1−ρ)]

In this equation

ρ* is one of the reflectances specified above

ρ is the corresponding reflectance prior to Saunderson correction

r₀ is the external reflection coefficient

r₂ is the internal reflection coefficient

In FIGS. 5 and 6 it is evident that at a wavelength below about 520 nm absorption is predominant whereas in the longer-wave region above 520 nm scattering is predominant, which is also responsible for the yellow color impression of the pigment.

Although all of the K(λ) and S(λ) spectra found are valid for the same Paliogen® L2140 pigment from BASF AG and have been standardized for the pigment concentration, and so theoretically ought to be the same, concentration-dependent differences are found, which may be caused, for example, by differences in the dispersing of the pigment in the coatings and/or by experimental effects of different magnitude, such as noise or nonuniform coat thicknesses, in the reflection spectra. It is therefore necessary to make a sensible selection for the values to be used in accordance with the process.

Generally speaking, the spectra taken as a basis for further calculation are those which exhibit a favorable signal-to-noise ratio: preferably, for calculating K(λ), those spectra which exhibit a favorable signal-to-noise ratio in the wavelength range which is relevant for absorption and, for calculating S(λ), those spectra which exhibit a favorable signal-to-noise ratio in the wavelength range which is relevant for scattering.

In this case the K(λ) spectrum used as a basis for further calculation comprises the values for the 1% pigmentation, since in the absorption range of the pigment (about <520 nm) only this level of pigmentation leads to a significant experimental difference in reflection data over the two different substrates. The lower reliability of the arithmetic results for K(λ) from the 5% and 10% pigmentations is evident from the noise of the K(λ) values in the absorption range (FIG. 5).

For similar reasons the values of the 10% pigmentation were chosen as the S(λ) spectrum.

These selected K(λ) and S(λ) spectra were smoothed by taking a moving average over 5 values, although such smoothing is not required by the invention.

Step e):

Standard commercial formulation software was used to determine the pigmentation for the shade RAL1007 Daffodil Yellow, with a total level of pigmentation of 10% in a 30 μm paint film over a white substrate. Pigments used were the following commercial products from BASF AG:

| Pigment | Amount used [%_{weight}] |
|---|---|
| Paliotol ® L 0962 HD | 55.4% |
| Paliotol ® L 2140 HD | 12.4% |
| Sicotan ® L 1912 | 32.2% |

For all three pigments the K(λ) and S(λ) spectra were determined in accordance with step c). Proportionally weighted addition of the K(λ) values and S(λ) values for the individual pigments gave the Kₜ(λ) and Sₜ(λ) spectra (FIG. 7), i.e., in this case Kₜ(λ)=55.4%·K(λ)_{L0962HD}+12.4%·K(λ)_{L2140HD}+32.2%·K(λ)_{L1912} and correspondingly for Sₜ(λ).

Step f):

To reproduce the shade RAL1007 Daffodil Yellow in step e) one possible pigmentation (formula 1) was described. Another possible pigmentation composition for reproducing RAL 1007 is formula 2:

| | Formula 1 | Formula 2 |
|---|---|---|
| Pigment | Amount used [%_{weight}] | Amount used [%_{weight}] |
| Paliotol ® L 0962 HD | 55.4% | |
| Paliotol ® L 2140 HD | 12.4% | 30.4% |
| Sicotan ® L 1912 | 32.2% | |
| Paliotan ® L 1145 | | 69.1% |
| Paliotol ® L 0080 | | 0.5% |

Proportionally weighted addition of the K(λ) values and S(λ) values for the individual pigments and analogous procedure gave the Kₜ(λ) and Sₜ(λ) spectra for formula 2 (FIG. 8).

It was necessary to determine which of the two formulas is preferable in terms of volume curing in a UV curing system from IST (type: U-300-M-2-TR) comprising one CK (“Hg”) and one CK1 (“Ga”) lamp with almost identical radiation output (see above). For both formulas the spectral transmission was calculated in accordance with the KMT and after application of the Saunderson correction (FIG. 9).

FIG. 9 describes how for the formula 1 at λ=370 nm about 1.2% of the light energy originally irradiated penetrates the entire pigmented layer and reaches the boundary layer between pigmented layer and substrate.

For the spectral intensity distributions of the two lamps the data from a lamp manufacturer (Hönle UV Technology) were used (FIG. 10). In accordance with the actual use of one CK lamp and one CK1 lamp, the sum of the distributions of the CK lamp and the CK1 lamp was used as the radiation distribution B(λ) for the operation in question.

The integral transmission Tᵢ for the actual spectral distribution B(λ) of the lamp radiation was calculated for both formulas from the transmission values of the respective formula and from the spectral data of the radiation output distribution as follows
Tᵢ=Σ(t_{λ}·b_{λ})/Σ(b_{λ});
the summation was from 280 nm-430 nm. Outside of this wavelength interval, lamp output and transmission do not contribute to volume curing, owing to the negligible activibility of the photoinitiator.

The following integral transmissions Tᵢ result for the two formulas:
Tᵢ(formula 1)=0.44%
Tᵢ(formula 2)=0.22%

This means that in the case of formula 1 0.44% and for formula 2 only 0.22% of the light energy originally irradiated penetrates the pigmented layer through to the boundary layer.

With the curing operation used, the higher transmission, i.e. greater light transmittance, of a coating with pigmentation according to formula 1 promises better volume curing than with pigmentation according to formula 2.

Step g)

The commercial formulating software already mentioned was used to determine six further pigmentations for the shade RAL1007 Daffodil Yellow, with 10% total pigmentation level in a 30 μm thick paint layer over a white substrate. The pigments mentioned above, plus further commercially customary pigments, were used for the calculation.

Coatings with all of the pigmentations—8 different pigmentations in total—were produced and cured in accordance with the operation specified above. The integral transmissions were between 0.04% and 0.44%.

The coatings were subjected to a rub test. In this test the cured coating was sheared with the fingernail parallel to the substrate and inspected for any surface damage, such as abrasion, flaking, cracks, corrugation or imprints, which point to insufficient substrate adhesion. In these tests, samples with Tᵢ values of up to 0.23% showed inadequate substrate adhesion; from Tᵢ values of 0.41% a significant improvement in adhesion, to a moderate level, can be observed, and above a Tᵢ value of 0.44% the adhesion is very good. This Tᵢ value is therefore set as T_{i,crit}. Consequently, in order to obtain a coating having effective substrate adhesion with the operation in question, any change to the pigmentation (pigment species, pigment concentration, layer thickness) must be chosen such that the associated Tᵢ value is at least 0.44%.

Step f)

Possibility 1: Systematic determination of the activability spectrum a_{λ} of a photoinitiator in a coating film

The activability spectrum of a photoinitiator could be determined by exposing a photoinitiator, one of those listed above for example, in an unpigmented binder composition, such as that specified in step b), for example, in a defined layer thickness for a defined time which, however, would have to be shorter than that necessary, from experience, for curing through volume, with light that as far as possible is monochromatic—for example, from a tunable laser or monochromator—in a known wavelength range, e.g., in a wavelength range which comprises 5 to 50 nm, preferably 5 to 30, more preferably 10 to 25 nm.

The exposed and therefore part-cured or through-cured coating material is subsequently examined for the degree of conversion of the chemical crosslinking reaction. This is done by means, for example, of quantifying the unreacted C═C double bonds by means of Raman spectroscopy.

Subsequently the experiment is carried out with an altered wavelength range but with experimental parameters otherwise the same, until the activability of the photoinitiator over the wavelength range in the absorption spectrum of the photoinitiator has been detected.

The results of the determination of the chemical conversion of the crosslinking reaction as a function of the wavelength range under consideration can be used as activability a_{λ} of the photoinitiator in order to calculate the activation A in accordance with the formula
A=Σ(t_{λ}·b_{λ}·a_{λ})/(Σ(b_{λ}))·Σ(a_{λ})).

Possibility 2: Empirical determination of the activability spectrum of a photoinitiator in a coating film

It has been found that the integral transmission of formula 1 is greater than that of formula 2, and in accordance with expectation improved adhesion was found for formula 1 as compared with formula 2.

The following paragraph represents a hypothetical consideration:

If, hypothetically, with equal values of the integral transmission and the spectral transmission profiles (see FIG. 9), it were to be found that formula 2 gave the better adhesion, then it could be assumed that formula 2, despite its lower integral transmission, possessed a predominant advantage by virtue of its higher spectral transmission in the range 300 nm to 350 nm. The power irradiated into the coating material in this wavelength range is lower both for the CK lamp and for the CK1 lamp than the power in the wavelength range >350 nm, but would be more efficiently converted into chemical crosslinking of the coating material, from which it would be possible to conclude that, in a hypothetical case of this kind, the activability of the photoinitiator in the wavelength range 300 nm to 350 nm was greater than in the longer-wave range.

Possibility 3: Systematic determination of the activability spectrum a; of a photoinitiator outside a coating film

The activability of a photoinitiator can also be determined outside a coating film, such as in a solution, for example. The values determined thereby differ from the values set out above in that they indicate the activability of the photoinitiator per se, by means for example of a quantum yield, but not its ability to initiate a polymerization in a coating material by means of free radicals.

For this purpose it would be possible to dissolve the desired photoinitiator in a suitable solvent and irradiate with light that as far as possible was monochromatic, from a tunable laser, for example, in a known wavelength range, e.g., a wavelength range which comprises 5 to 50 nm, preferably 5 to 30, more preferably 10 to 25 nm.

The free radicals generated in the course of this exposure can be measured, for example, noninvasively, by means of a ESR probe, for example, or captured invasively, by means, for example, of a dye which can be scavenged free-radically, such as triphenylmethane, diphenylpicrylhydrazine, nitrosobenzene, 2-methyl-2-nitrosopropane or benzaldehdye tert-butyl nitrone, for example products captured with free-radical scavengers can then, for example, be titrated or determined photometrically.

Accordingly, in this way, it is possible to determine the amount of free radicals generated by the photoinitiator as a function of the wavelength. This value must be multiplied by an effectiveness factor which in general is between 0.3 and 1.0, preferably between 0.4 and 0.95, more preferably between 0.5 and 0.9, in order to indicate the free-radical reactions effectively initiated by the photoinitiator in the coating material.

### LIST OF FIGURES

FIG. 1: Spectral reflection of the coatings with different pigmentation concentrations over aluminum (a) or black (b) substrate in the spectral range 200-1000 nm

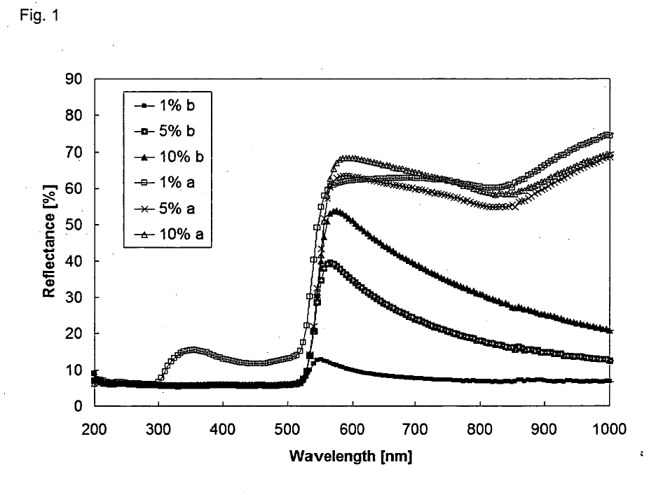

FIG. 2: Spectral reflection of the substrates in the spectral range 200-1000 nm and 200-800 nm respectively

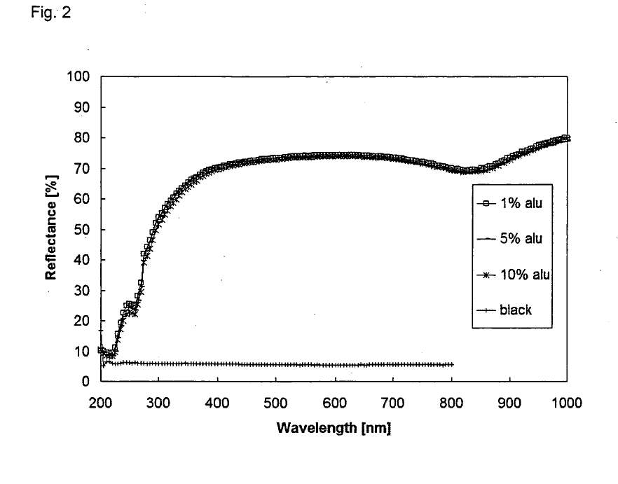

FIG. 3: Saunderson-corrected reflection spectra of the pigment concentrations from b)

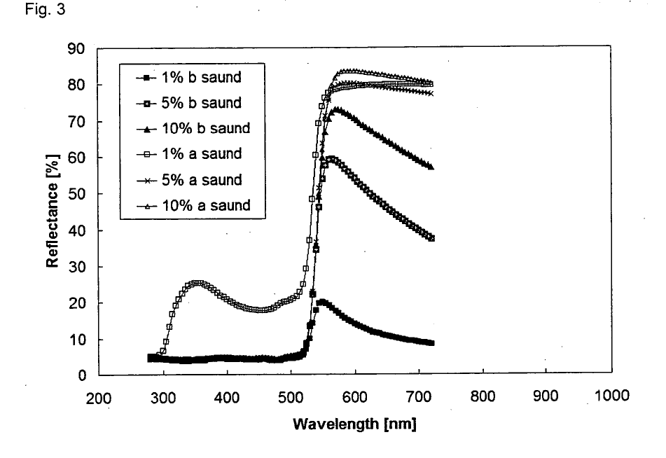

FIG. 4: Saunderson-corrected reflection spectra of the substrates

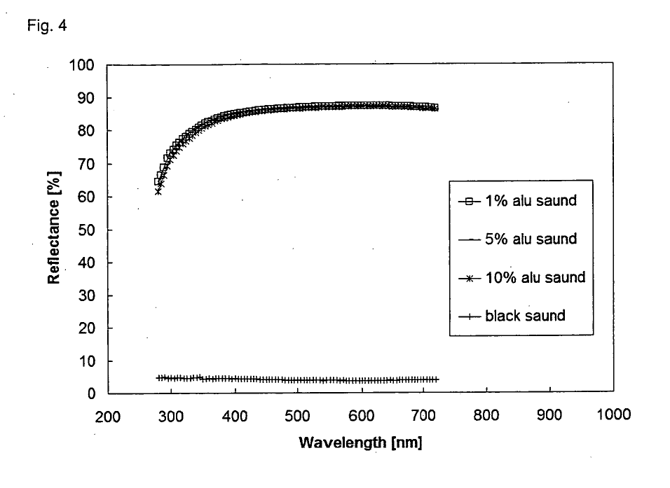

FIG. 5: Concentration-specific absorption (K) spectra, calculated using the KMT, of the pigment concentrations from b) [(μm·%)^{-1]}

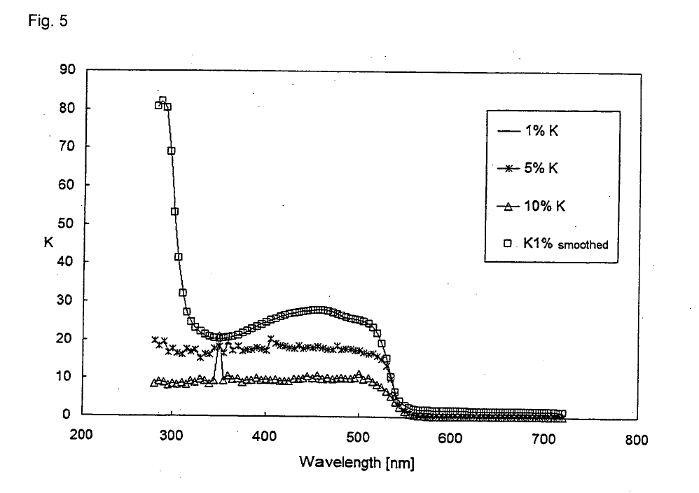

FIG. 6: Concentration-specific scattering (S) spectra, calculated using the KMT, of the pigment concentrations from b) [(μm·%)^{-1]}

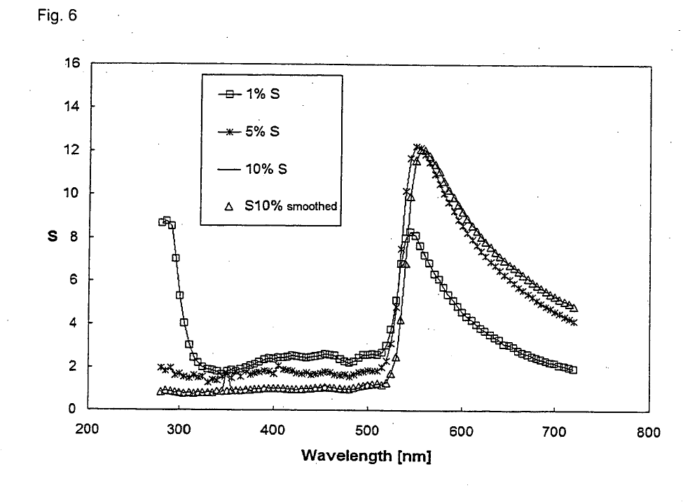

FIG. 7: Total absorption (Kₜ_{^{−}}) and total scattering (Sₜ_{^{−}}) spectra for pigment composition Daffodil Yellow in accordance with formula 1 [(μm·%)^{-1]}

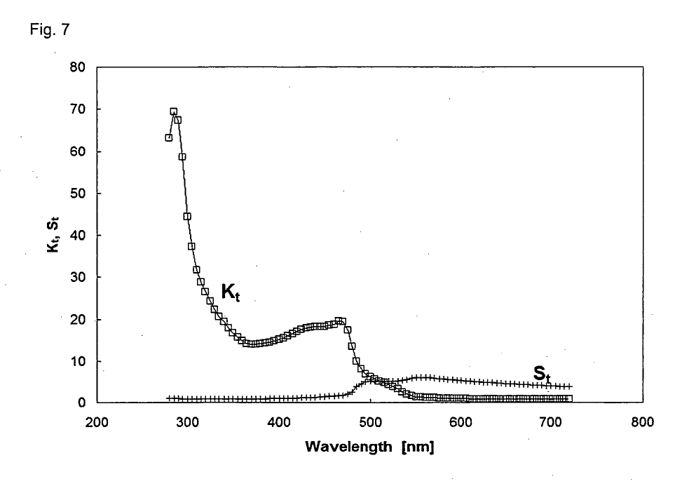

FIG. 8: Total absorption (Kₜ_{^{−}}) and total scattering (Sₜ_{^{−}}) spectra for pigment composition Daffodil Yellow in accordance with formula 2 [(μm·%)^{-1]}

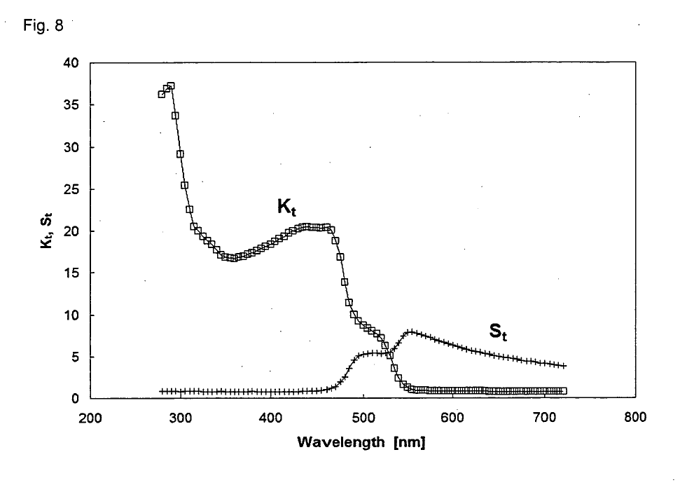

FIG. 9: Spectral transmission for formulas 1 and 2

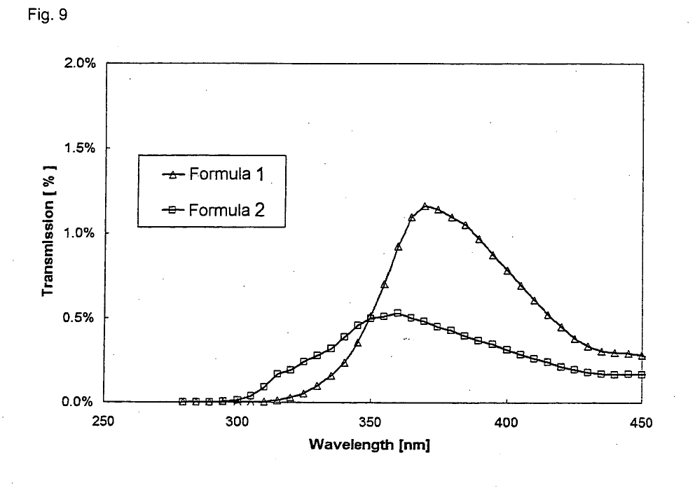

FIG. 10: Typical emission spectra of the lamp types used in the exposure system employed, each standardized to a total intensity of 1 in the wavelength range 280-430 nm

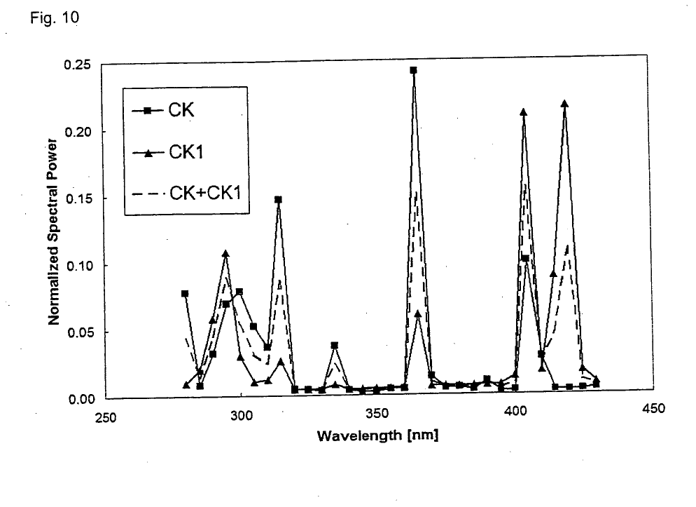

1-11. (canceled)

12: A method of determining conditions for radiation curing radiation-curable pigmented coating materials including at least one pigment, at least one binder, and at least one photoinitiator on a substrate, the method comprising:
a) specifying a pigment composition or determining the pigment composition required to obtain a desired color impression;
b) measuring reflection spectra of the pigments present in the pigment composition, as a function of their concentration, composition, and/or coat thickness;
c) determining concentration-specific absorption spectra and scattering spectra of the individual pigments from the reflection spectrum measured in b), in a desired wavelength range;
d) measuring reflection of the substrate in the desired wavelength range;
e) determining values for total absorption and total scattering of the coating material on the substrate from values from c) and d) for the desired pigment composition;
f) determining integral transmission for the pigment composition in the desired wavelength range; and
g) determining variables necessary for radiation curing based on the integral transmission determined in f).

13: A method according to claim 1, further comprising:
h) implementing radiation curing of the coating based on the variables determined in g).

14: The method according to claim 13, wherein radiation curing is formed in h) with up to 200% of the radiation dose calculated in g).

15: The method according to claim 12, wherein the concentration-specific absorption spectra and scattering spectra are determined in accordance with the Kubelka-Munk theory.

16: The method according to claim 12, wherein the concentration-specific absorption spectra and scattering spectra are determined in accordance with the four-channel or multichannel theory.

17: The method according to claim 12, wherein the spectra measured in b) and/or d) are Saunderson-corrected.

18: The method according to claim 12, further comprising:
determining an integral transmission Tᵢ and a critical integral transmission T_{i,crit} that the coating must at least have to achieve a desired volume curing through the entire pigmented coat down to the substrate, and, in the event that Tᵢ<T_{i,crit},
either choosing a new pigment composition in step a) and running through the sequential steps again until the condition Tᵢ≧T_{i,crit} is met,
or choosing a reduced coat thickness for which Tᵢ≧T_{i,crit} is met, radiation curing in accordance with step h), and then applying coating material with the reduced coat thickness and radiation curing until the coat thickness is at least reached.

19: The method according to claim 12, wherein activability of the photoinitiator used is taken into account.

20: An apparatus for implementing radiation curing as set forth in claim 12, comprising at least one illumination unit and at least one arithmetic unit and also if appropriate at least one measuring unit, the arithmetic unit configured to determine information for implementing radiation curing up to and including g) and the illumination unit being used to implement radiation curing with said information thus determined.

21: The use of apparatus according to claim 20 in radiation curing.

22: A method of radiation curing, which comprises a supplier providing a user with a program for implementing a method according to claim 12, with an attached database recording basic data of pigments and substrates, or with information compiled using such a program, and the user implementing radiation curing using the information.
